(19) United States
(12) Patent Application Publication
(10) Pub. No.: US 2018/0044119 A1
(43) Pub. Date: Feb. 15, 2018

(54) Loading Car With Separately Activatable Discharge Devices

(71) Applicant: Plasser & Theurer Export Von Bahnbaumaschinen Gesellschaft M.B.H, Wien (AT)

(72) Inventor: PATRICK HOETZENDORFER, ENGERWITZDORF (AT)

(73) Assignee: Plasser & Theurer Export Von Bahnbaumaschinen Gesellschaft M.B.H, Wien (AT)

(21) Appl. No.: 15/323,325

(22) PCT Filed: Jun. 5, 2015
(86) PCT No.: PCT/EP2015/001145

§ 371 Date: Dec. 30, 2016

(30) Foreign Application Priority Data
Jul. 1, 2014 (AT) A 525/2014

(51) Int. Cl. B65G 47/72; B65G 67/08; B65G 67/24; B65G 47/58

(52) U.S. Cl. CPC B65G 47/72; B65G 47/58; B65G 67/08; B65G 67/24; B65G 2812/02; B65G 2812/08

(57) ABSTRACT

A loading car for picking up, transporting onward and discharging bulk material has a car frame supported on on-track undercarriages and a distributing conveyor belt extending in a longitudinal direction of the car, for transporting the bulk material to discharge devices. The distributing conveyor belt is constructed to be displaceable in the longitudinal direction of the car for selectively charging the discharge devices. A first discharge device is constructed as a chute disposed above a track. A second as well as a third discharge device are constructed in each case as a conveyor belt pivotable about a vertical axis and each has a receiving end positioned in the region of the axes.

The invention relates to a loading car for picking up, transporting onward and discharging bulk material, including a car frame supported on on-track undercarriages and a distributing conveyor belt, extending in a longitudinal direction of the car, for transporting the bulk material to discharge devices.

According to WO 2013/189564 A1, a ballast plough is already known which contains a silo. The latter may be unloaded via a chute or via conveyor belts.

Further loading cars are evident from GB 2 264 275 A and EP 0 096 236 A1.

It is the object of the present invention to provide a loading car of the type mentioned at the beginning with which a discharging of bulk material is possible in many variants.

According to the invention, this object is achieved with a loading car of the specified kind by way of the features cited in the characterizing part of the main claim.

By means of a loading car of this type, the bulk material to be discharged can be ejected, as desired, either into the track, laterally next to the track or onto the bedding shoulder, or also onto cars situated on the neighboring track. If the third discharge device is configured accordingly, discharge is also possible onto cars situated on the track travelled upon. The loading car can be employed in combination with a cleaning machine or with machines for track- or formation rehabilitation. The bulk material discharged by the loading car can either be reintroduced into the track (cleaned ballast, for example), or new material is introduced (for example, new ballast, gravel, sand). Additionally, it is possible to transport away material and spoil which is no longer needed or soiled. Further advantages of the invention become apparent from the dependent claims and the drawing description.

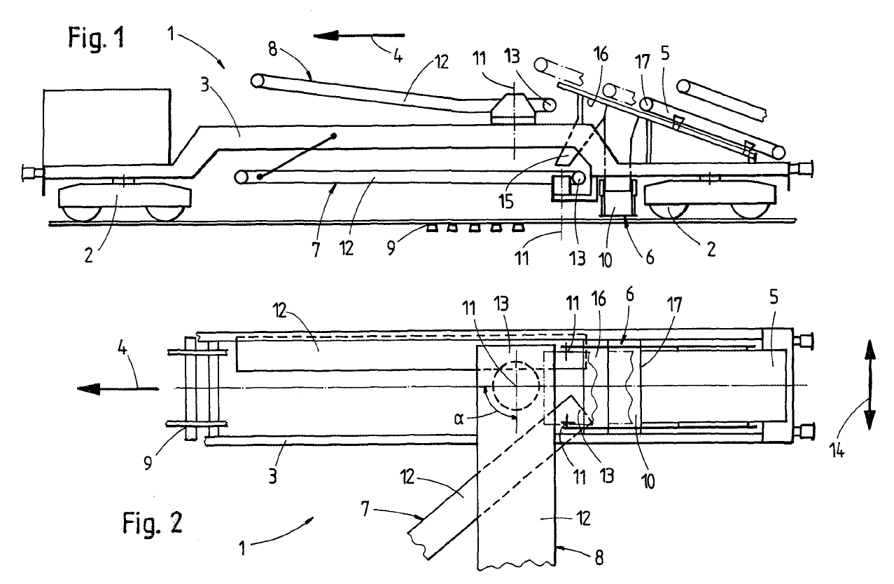

The invention will be described in more detail below with reference to an embodiment represented in the drawing in which FIG. 1 shows a side view and FIG. 2 a top view of a loading car.

A loading car 1, represented in FIGS. 1 and 2, for picking up, transporting onward and discharging bulk material consists essentially of a car frame 3 supported on on-track undercarriages 2. Arranged on the same is a distributing conveyor belt 5, extending in a longitudinal direction 4 of the car, for transporting the bulk material to discharge devices 6, 7, 8. The distributing conveyor belt 5 is designed to be adjustable in the longitudinal direction 4 of the car for selectively charging the discharge devices 6, 7, 8. The first discharge device 6 is designed as a chute 10 arranged above a track 9. The second as well as the third discharge device 7, 8 are designed in each case as a conveyor belt 12 pivotable about a vertical axis 11, each having a receiving end 13 positioned in the region of the axes 11. The second discharge device 7 is arranged underneath the car frame 3, and the third discharge device 8 is arranged above the car frame 3.

The second discharge device 7 consists of a total of two conveyor belts 12 pivotable independently of one another about vertical axes 11 and arranged side-by-side with regard to a transverse direction 14 of the car. The conveyor belt 12 of the third discharge device 8 is designed to be pivotable about an angle a of preferably 90°. A chute 15 is arranged between the distributing conveyor belt 5 and the second discharge device 7 arranged underneath the car frame 3, the chute 15 having a receiving end 16 positioned between a discharge end 17 of the distributing conveyor belt 5 and the receiving end 13 of the third discharge device 8 arranged above the car frame 3.

In operation, the distributing conveyor belt 5 is displaced—depending on the desired discharge point—in such a way that the discharge end 17 thereof is located immediately above the corresponding discharge device 6, 7, 8. As shown in FIG. 1, the discharge end 17 is located above the first discharge device 6. Thus, the bulk material is discharged into the chute 10; ergo a discharge of material takes place into the track 9 on which the loading car 1 travels. Other positions of the distributing conveyor belt 5 are indicated in dash-and-dot lines. In a central position, the discharging takes place via the chute 15 onto the second discharge device 7 and from there laterally adjacent to the track 9 or onto the bedding shoulder of the same. In the front-most position, with respect to the longitudinal direction 4 of the car, the discharging takes place onto the third discharge device 8. If the conveyor belt 12 of the latter is pivoted about the angle a of 90°, it is possible to charge cars located on the track adjacent to the track 9. If the conveyor belt 12 of the third discharge device 8 is designed with corresponding length, it is also possible to charge cars located on the track 9 which precede the loading car 1.

1-5. (canceled)

6. A loading car for picking up, transporting onward and discharging bulk material, the loading car comprising:
on-track undercarriages;
a car frame supported on said on-track undercarriages;
first, second and third discharge devices supported on said car frame;
said first discharge device being constructed as a chute disposed above a track;
said second and third discharge devices each being constructed as a respective conveyor belt pivotable about a respective vertical axis, each of said conveyor belts having a receiving end positioned in a vicinity of a respective one of said vertical axes; and
a distributing conveyor belt extending in a longitudinal direction of the loading car for transporting the bulk material to said first, second and third discharge devices, said distributing conveyor belt being displaceable in the longitudinal direction of the loading car for selectively charging said first, second and third discharge devices.

7. The loading car according to claim 6, wherein said second discharge device is disposed underneath said car frame, and said third discharge device is disposed above said car frame.

8. The loading car according to claim 7, wherein said second discharge device includes a total of two conveyor belts being pivotable independently of one another about said axes and being disposed side-by-side relative to a transverse direction of the loading car.

9. The loading car according to claim 7, wherein said conveyor belt of said third discharge device is pivotable about an angle of 90°.

10. The loading car according to claim 6, wherein:
said second discharge device is disposed underneath said car frame;
said third discharge device is disposed above said car frame;
said distributing conveyor belt has a discharge end; and
a chute is disposed between said distributing conveyor belt and said second discharge device, said chute having a receiving end positioned between said discharge end of said distributing conveyor belt (5) and said receiving end of said third discharge device.
